(19) United States
(12) Patent Application Publication
(10) Pub. No.: US 2026/0055975 A1
(43) Pub. Date: Feb. 26, 2026

(54) HEAT EXCHANGER

(71) Applicant: Conflux Technology Pty Ltd, Grovedale, Victoria (AU)

(72) Inventors: Gabrian BALELANG, Grovedale, Victoria (AU); Ashley DOWLE, Grovedale, Victoria (AU); Michael FULLER, Grovedale, Victoria (AU)

(21) Appl. No.: 19/103,477

(22) PCT Filed: Aug. 9, 2023
(86) PCT No.: PCT/AU2023/050751

§ 371 Date: Feb. 12, 2025

(30) Foreign Application Priority Data
Aug. 12, 2022 (AU) 2022902285

(51) Int. Cl. F28F 3/04; B23P 15/26; B33Y 80/00

(52) U.S. Cl. CPC F28F 3/04; B23P 15/26; B33Y 80/00

(57) ABSTRACT

A heat exchanger for transferring heat between a first fluid and a second fluid, comprising a housing having a passageway for the first fluid and an internal member located within and extending along a length of the passageway that is configured to carry the second fluid in a direction substantially parallel to that of the first fluid; wherein the internal member is formed from a thermally conductive material and includes an active region adapted to spread the second fluid flow substantially evenly across a width of the passageway.

### TECHNICAL FIELD

The invention is directed broadly towards a heat exchanger. In particular, there is provided a heat exchanger having a passageway and an internal member within the passageway for transferring heat between a first fluid flow and a substantially parallel second fluid flow.

### BACKGROUND

A heat exchanger is a system used to transfer heat between two or more working fluids. Depending on the relative direction of flow of the respective working fluids, heat exchangers can be broadly classified into several forms. In counterflow heat exchangers, the working fluids flow parallel to one another, in opposing directions. This is to be contrasted with crossflow heat exchangers, where the working fluids flow perpendicular to one another. Generally speaking, counterflow heat exchangers—also known as countercurrent heat exchangers—are considered to provide overall better performance and are thus preferred over crossflow alternatives for certain applications.

Existing counterflow heat exchangers generally take one of two types. Tube-type heat exchangers comprise several inner tubes or channels that are surrounded by a single outer tube or jacket, with a first fluid flowing through the inner tubes and a second fluid flowing through the outer tube in a direction opposite to that of the first fluid. Tube-type heat exchangers are simple to make and reliable, however are limited in overall performance due to the relatively small surface area for heat transfer. Plate-type heat exchangers, on the other hand, comprise a series of plates that are staggered along a length of the part, with narrow spaces between adjacent plates defining channels for fluids to flow through a height of the part. Grooves or gaskets that are machined into the plates permit fluid flow in one direction only, with the plates being arranged such that hot and cold fluids respectively flow between every alternate pairs of plates. Whilst plate-type heat exchangers offer greater potential heat transfer per a similar size part compared to Tube-type heat exchangers, the gaskets or seals between the plates are prone to leakages resulting in contamination of the fluid streams.

In both types of counterflow heat exchangers, overall heat transfer performance is dependent on the total surface area for heat exchange provided between the adjacent fluid flows. Conventional fabrication techniques impose limitations on the surface geometries that are possible through machining. Furthermore, typical heat exchangers involve the interconnection of several components and sub-parts, where it is important to ensure a tight seal to prevent contamination or mixing of the different fluid flows. Conventional assembly methods are laborious and susceptible to poor connections, which can lead to system failure.

Within this context, there is a need for an improved heat exchanger or to at least provide the public with a useful choice. The present invention was conceived with these shortcomings in mind.

### SUMMARY

In a first aspect, the invention provides a heat exchanger for transferring heat between a first fluid and a second fluid, comprising a housing having a passageway for the first fluid and an internal member located within and extending along a length the passageway that is configured to carry the second fluid in a direction substantially parallel to that of the first fluid; wherein the internal member is formed from a thermally conductive material and includes an active region adapted to spread the second fluid flow substantially evenly across a width of the passageway.

Preferably, heat exchanger is a counterflow heat exchanger with the first and second fluids passing therethrough in substantially opposite directions.

In some embodiments, the heat exchanger may further comprise an inlet and an outlet in fluid communication with the internal member, with one of the inlet and the outlet being disposed towards a first end of the internal member and the other of the inlet and the outlet being disposed towards an opposite second end of the internal member. The internal member may extend laterally between a first side and a second side, with the inlet being located on the first side and the outlet being located on the opposing second side. Additionally or alternatively, the housing may extend in height between an upper side and a lower side, with the inlet extending away from the lower side and the outlet extending away from the upper side.

The internal member may include a passive region, with the passive region being located before the active region in the direction of the second fluid flow. The passive region of the internal member may have a variable length across a width thereof. The length of the passive region may decrease across the width of the internal member, from the first side to the second side. The length of the passive region may vary linearly across the width of the internal member.

Optionally, the plate may include a second passive region, with the second passive region being located after the active region in the direction of the second fluid flow.

In some embodiments, the internal member may include a plurality of internal protuberances that define the active region. The plurality of protuberances may be provided as an array. The array may be an array of discrete turbulators.

The internal member may include a plurality of external projections that extend into the passageway.

In some embodiments, the internal member comprises a plurality of plates located within the passageway, with each of the plates having an interior channel along which a portion of the second fluid flow passes in the second direction. The plurality of plates may be spaced in a stacked arrangement within the passageway so as to divide the passageway into a plurality of substantially evenly sized separate passages, with portions of the first fluid flow passing therealong. The heat exchanger may further comprise a manifold configured to distribute the respective portions of the second fluid flow across the channels of the plurality of plates.

The first fluid flow may be a gas flow. Additionally or alternatively, the second fluid flow may be a liquid flow.

Preferably, the housing and the plate(s) are integrally formed with one another.

In a second aspect, the invention provides a method of manufacturing the heat exchanger as described herein, with the method including forming the housing and the internal member simultaneously through an additive manufacturing process.

### BRIEF DESCRIPTION OF THE DRAWINGS

The invention will now be described, by way of non-limiting example only, with reference to the accompanying drawings, in which:

FIG. 1 is a perspective view of a heat exchanger according to an embodiment of the invention, the heat exchanger having a generally rectangular housing, an interior volume of which defining a core for heat exchange between a first fluid flow and a second fluid flow;

FIG. 2 is a side view of the heat exchanger of FIG. 1, showing an inlet and an outlet that extend from the housing;

FIG. 3 is a bottom view of the heat exchanger of FIG. 1;

FIG. 4 is a front view of the heat exchanger of FIG. 1;

FIG. 5 is a sectional view of a plate through the line A-A of FIG. 4, showing an interior channel of the plate through which the second fluid flow passes;

FIG. 6 is a perspective view of the sectioned plate of FIG. 5, showing an active region and a passive region of the plate;

FIG. 7 is an enlarged view of the encircled region B of FIG. 6, showing an array of protuberances that define the active region;

FIG. 8 is a schematic end view of the heat exchanger of FIG. 1, showing the path of a first fluid flow from the inlet to the outlet via the interior channel;

FIG. 9 is a schematic plan view of the heat exchanger of FIG. 1, showing the spread of the first fluid flow across the width of the active region of the plate;

FIG. 10 is a perspective view of a heat exchanger according to a preferred embodiment of the invention, with the heat exchanger including external projections that extend from the plates thereof;

FIG. 11 is an enlarged view of the external projections of FIG. 10, showing an array of intermeshing fins;

FIG. 12 is a side sectional view along a length of the heat exchanger of FIG. 10, showing the fins extending between adjacent plates; and

FIG. 13 is an enlarged view of the encircled region C of FIG. 12, showing the fins and the internal structure of the plate.

### DETAILED DESCRIPTION

In the following detailed description, reference is made to accompanying drawings which form a part of the detailed description. It will be readily understood that the aspects of the present disclosure, as generally described herein and illustrated in the drawings may be arranged, substituted, combined, separated and designed in a wide variety of different configurations, all of which are contemplated in this disclosure.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the example methods and materials are described herein.

In general terms, the heat exchanger unit 100 shown in the Figures comprises a shell-like housing 102 having an interior volume, at least a portion thereof defining a core 101 of the heat exchanger unit 100. The core 101 represents a heat transfer zone of the unit 100. A passageway 104 extends axially along the housing 102. The passageway 104 provides a path for a first fluid to flow along the core 101 in a first direction. An internal member 106 is located within the passageway 104, extending across a width thereof. The internal member 106 serves as a baffle, providing a path for a second fluid to flow along the core 101, substantially parallel to the first fluid. The internal member 106 is formed from a conductive material such that heat is transferred between the respective fluids. The internal member 106 includes an active region 110 that is adapted to spread the second fluid flow substantially evenly across a width of the passageway 104, to thereby optimize heat transfer efficiency between the fluids within the core 101.

In this specification, the term “fluid” is taken to encompass both gaseous fluids such as air and liquids such as water. In particular, it is understood that the heat exchanger unit 100 described herein is suitable for use as a liquid-liquid heat exchanger as well as a liquid-gas heat exchanger.

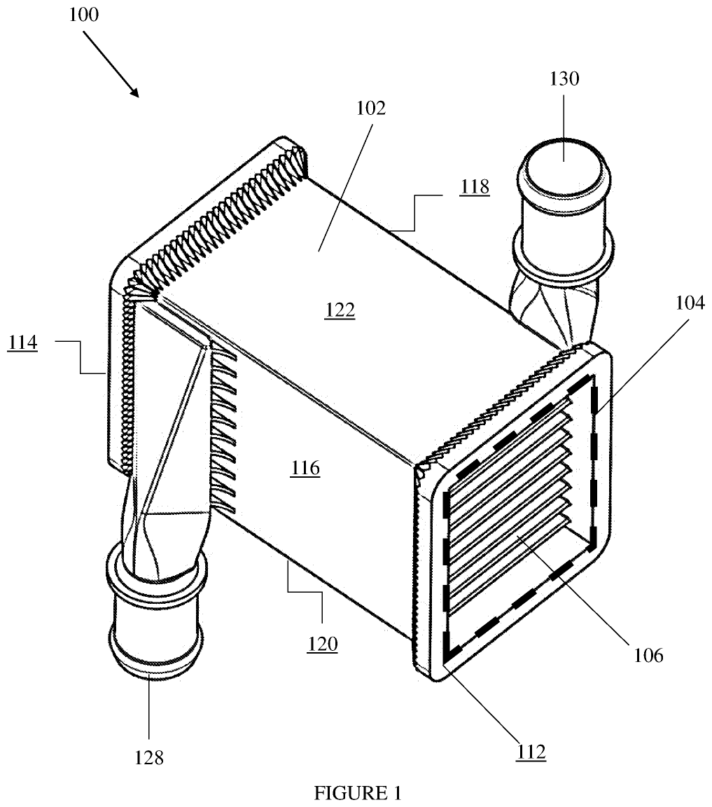

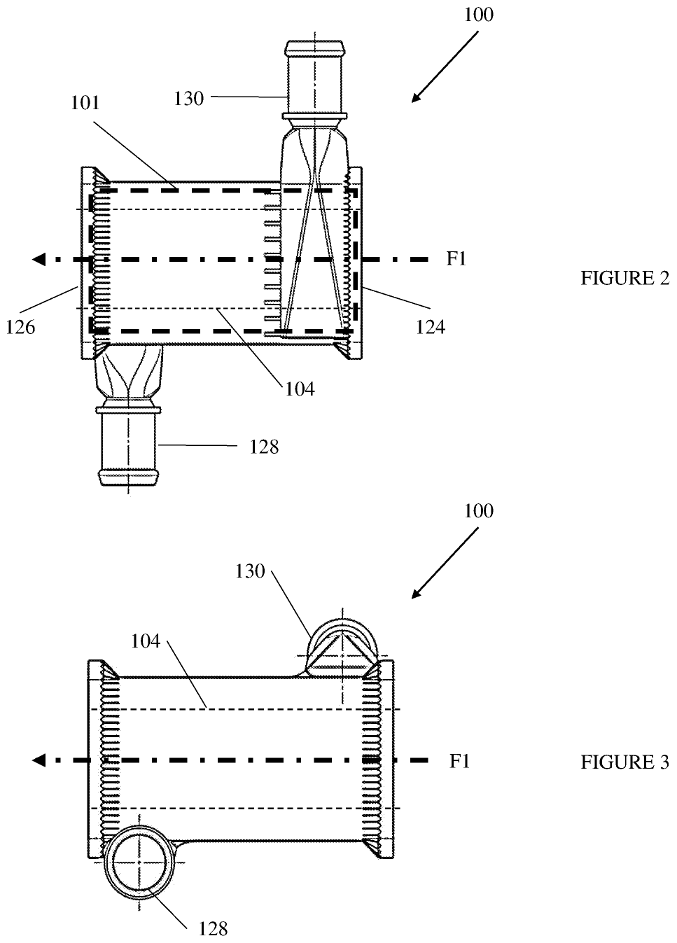

With particular reference to FIGS. 1 to 3, the housing 102 of the heat exchanger unit 100 is a box-shaped shell body that extends axially in length between a first or front end wall 112 and a second or rear end wall 114, and laterally in width between a first or near side wall 116 and a second or far side wall 118. Opposing lower 120 and upper 122 walls enclose the volume of the housing 102. It is understood, however, that the housing 102 need not be rectangular or box-shaped. In other examples, the housing 102 (and thus the core 101 enclosed therein) may have different shapes such as a body having a circular profile, a triangular profile, any other geometric profile, or any other non-geometric or freeform profile. By way of further example, the housing 102 may be substantially cylindrical, spherical, or other volumetric shape with perpendicular planes or with a curved or freeform surface profile. It is further noted that whilst the housing 102 of the illustrated embodiment has a constant cross-sectional area and profile, it us understood that this is merely a preferment and is not a requirement of the invention.

The passageway 104 extends linearly along the housing 102 from the first end 112 to the second end 114. The passageway 104 has a rectangular cross-section. The passageway 104 provides the pathway for the first fluid flow to pass through the unit 100 in a first, substantially axial direction designated in the Figures as F1. The passageway 104 completely surrounds the plate 106 located therein, such that the first fluid flow may be considered as an external fluid flow, whilst the second fluid flow (within the interior channel 108 of the plate 106 and designated in the Figures as F2) may be considered as an internal fluid flow. Whilst the illustrated embodiments show the passageway 104 as encompassing substantially the entire interior volume of the housing 102, it is understood that this need not be the case. For example, the passageway 104 can, for example, be provided as a tubular pipe that extends through the housing 102.

Openings within the end walls 112, 114 provide, respectively, an intake 124 and an exhaust 126 for the first fluid flow. As illustrated, the intake 124 and exhaust 126 are open, with the first fluid flow being exhausted out of the heat exchanger. Such an embodiment is suitable for gas-based fluids such as air. In other embodiments, the intake 124 and exhaust 126 may take the form of pipes or other closed bodies, suitable for the passage of liquids. It is understood that the heat exchanger unit 100 is a single-pass heat exchanger, with the first fluid flow passing through the core 101 in a single pass, thereby maximizing the rate of heat transfer between the first and second fluid flows.

The second fluid flow enters the heat exchanger unit 100 via an inlet 128, and exits via an outlet 130. Best shown in FIG. 3, the inlet 128 and outlet 130 have a circular cross-section suitable for coupling with conventional tubular pipes. The inlet 128 and the outlet 130 are in fluid communication with the internal member 106. In the embodiment shown in the Figures, the inlet 128 is provided towards the second end 114 of the housing 102, whilst the outlet 130 is provided towards the first end 112. In this way, it is understood that the direction of flow of the second fluid along the core 101 is from the second end 114 to the first end 112, counter or opposite to the direction of the first fluid flow. It is understood that in other embodiments, the respective positions of the inlet 128 and the outlet 130 can be reversed, such that the first and second fluids flow in the same direction along the core 101.

The inlet 128 extends downwardly from the first side wall 116, away from the lower wall or base 120, whereas the outlet 130 extends upwardly from the opposing second side wall 118, away from the upper wall or top 122. The positioning of the inlet 128 and outlet 130 towards opposing sides of the internal member 106 provides a lateral component to the direction of the second fluid flow, encouraging the flow to spread across the width of the plate 106 and minimize the effects of thermal bias.

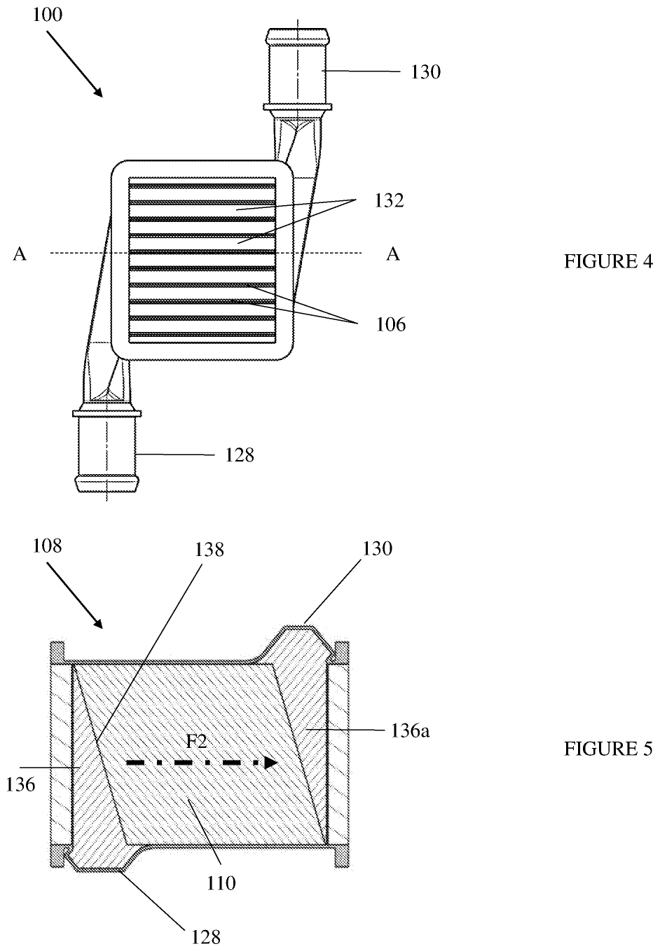

Turning now to FIG. 4, where it can be seen that the internal member 106 comprises a plurality of flat plates 106 that extend along a substantial length of the passageway 104. As illustrated, there are eight plates 106 located within and extending along the passageway 104, however it is understood that depending on the overall size of the heat transfer unit 100 and/or the nature and characteristics of the respective working fluids, there could be more or less plates 106. For example, some embodiments may include as little as a single plate 106, whilst other embodiments may include 10, 15 or 20 or more plates. It is also contemplated that the internal member 106 may not extend along a complete length of the housing 102, for example, several heat exchanger units 100 may be arranged so as to share a common housing 102. Furthermore, in other embodiments (not shown), it is understood that the internal member 106 may not be flat or otherwise plate-like. For example, the internal member 106 may, alternatively, provided as a curved plate, or in other embodiments, as a tubular pipe or as a plurality of tubular pipes.

The plates 106 are positioned in a stacked arrangement about the height of the passageway 104. Spacings or gaps between adjacent plates 106 provide passages 132 for the first fluid to flow. Preferably, the plates 106 are distributed evenly and regularly across the height of the passageway 104 such that the portions of the first fluid within each of the respective passages 132 are approximately the same. As is clearly shown in the Figures, the plates 106 extend across a complete width of the passageway 104 and along a substantial length thereof, such that the respective passages 132 are sealed off from one another and mixing does not occur between the portions of the first fluid until the portions recombine towards the exhaust 126.

Best shown in FIGS. 5 to 7, each of the plates 106 includes at least one interior channel 108. In the preferred embodiment shown in the Figures, the interior channel 108 is provided as a slot that extends substantially across the complete width of each of the plates 106. The interior channel 108 provides the pathway for the second flow of fluid. The interior channel 108 is a closed or sealed channel, such that there is no mixing of fluid flows. The surface area of the channel 108 is divided up into an active region 110 and at least one passive region 136. The passive region 136 has a lower coefficient of surface friction than the active region 110. In this way, the active region 110 may be considered to be a “roughened” region of the channel 108 with the passive region(s) 136 being “smoothened” regions. The region 108 is configured such that for a given flow rate the active region 110 encourages turbulent fluid conditions whereas the passive region 136 encourages a more laminar flow. The turbulent fluid flow condition within the active region 110 of the channel 108 encourages mixing of the second fluid and is beneficial in promoting heat transfer between the first and second fluids.

The active region 110 is the working region of the interior channel 108, and covers the complete width of the channel 108, whilst extending along a substantial length thereof. The passive region 136 is located before the active region 110 in the direction of travel of the second fluid. In this way, fluid that enters into the channel 108 via the inlet 128 passes through the passive region 136 prior to encountering the active region 110, where the roughened surface thereof works the second fluid flow into a turbulent flow condition. A second passive region 136a is located after the active region 110, such that the second fluid passes over the second passive region 136a, substantially stabilizing the flow prior to its exit from the channel 108 via the outlet 130.

With particular reference to FIG. 5, a boundary or transition 138 between the passive region 136 and the active region 110 extends across the width of the channel 108 at an angle with respect to the end walls 112, 114. In this way, the passive region 110 has a variable length across the width of the channel 108, with a maximum length along the edge thereof adjacent to the inlet 128. Likewise, the second passive region 136a also has a variable length across the width of the channel 108, with a maximum length being along the edge thereof adjacent to the outlet 130. As shown in the Figures, the boundary or transition 138 extends linearly across the width of the channel 108. It is understood, however, that the boundary or transition 138 can also follow other profiles, for example a sinusoidal profile, in order to obtain different flow/boundary characteristics of the second fluid.

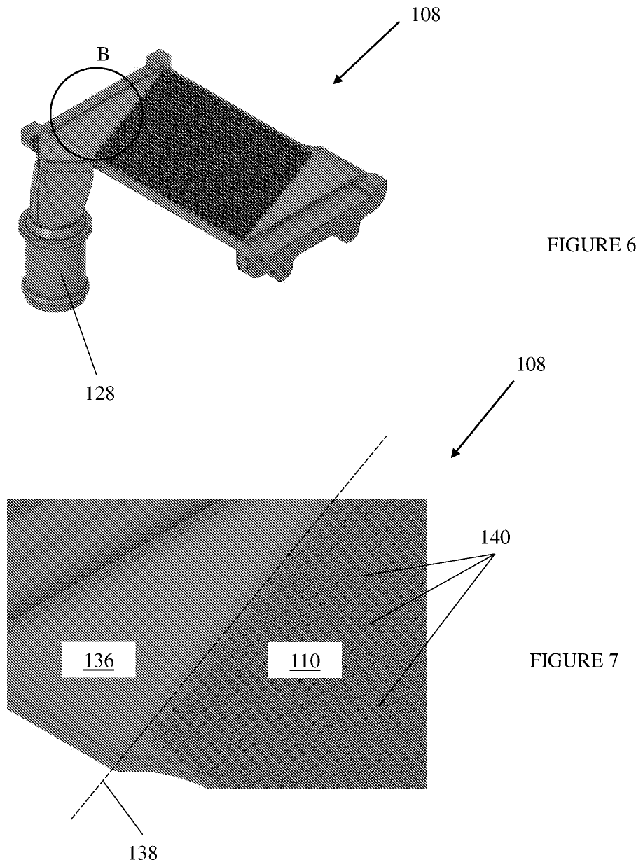

The geometry of the active region 110 will now be discussed with reference to FIGS. 6 and 7. Best detailed in FIG. 7, the active region 110 is characterized by a plurality of upstanding protuberances 140 that extend from an internal channel wall of the plate 106, into the channel 108. The protuberances 140 embody the active region with a roughened surface profile. The protuberances 140 are adapted to serve as turbulators, to thereby impart a turbulent flow condition onto the second fluid flow to encourage the flow to spread or cover the full width of the channel 108 and thereby increased heat transfer with the first fluid flow within the adjacent passageway 104. The height of the protuberances 140 is selected based on the flow characteristics of the second fluid, to ensure optimal spread and encourage heat transfer. For example, the protuberances 140 may stretch substantially across the entire height of the channel 108. As shown, the protuberances 140 are provided as an array of discrete turbulators. In other embodiments (not shown) it is also contemplated that the protuberances 140 may be provided as a lattice-like formation. Optionally, the passive region 136 may also include protuberances 140. It is understood, however, that such protuberances of the passive region are of a reduced height and/or density relative to those of the active region 110. Accordingly, the active region 110 has an increased or roughened texture resulting in a higher surface friction when compared to that of the passive region 136.

As illustrated, the protuberances 140 extend between the inner channel walls of the plate 106. The protuberances 140 can also serve to increase the structural strength of the plates 106. This is particularly beneficial in that it enables the plates 106 to be provided with relatively thin walls (compared to existing/conventional plates) that promote increased rates of heat transfer. In other embodiments, the protuberances 140 may take on other forms, such as raised dimples and the like and/or may not extend across the complete height of the channel 108. The protuberances 140 may serve as a scaffold during an additive manufacturing process of the plates 106, holding apart and enabling the formation of upper and lower interior channel walls of the plate 106 that define the channel 108.

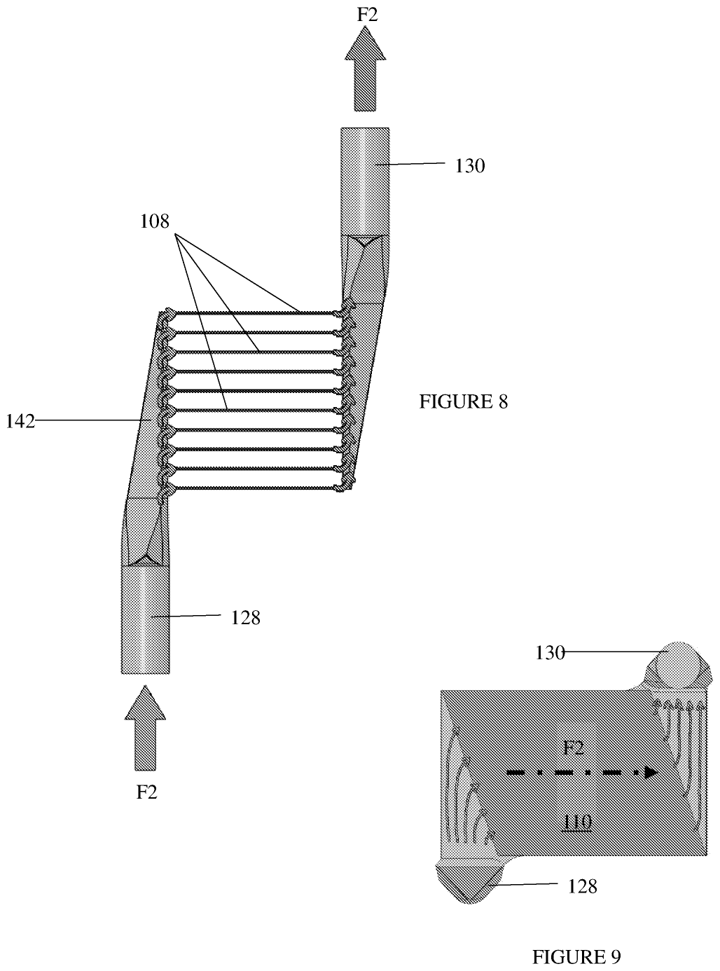

The path of the second fluid flow will now be discussed with reference to FIGS. 8 and 9. As shown in FIG. 8, the second fluid enters the core 101 via the inlet 128. A manifold or splitter 142 then separates the second fluid flow into several branches, with each branch being directed towards the channel 108 of a respective plate 106. Each of the branches of the second fluid flow then travel both axially along the channel 108 (in a direction opposite to that of the flow of first fluid), and laterally across the channel 108 to the outlet 130, where the branches are recombined into a combined exit flow.

With particular reference to FIG. 9, it is noted that the variable length of the passive region 136 (or, put differently, the shape of the active region 110 when considered from a plan view of the plate) encourages the second fluid flow to spread substantially evenly across the complete width of the channel 108. The spread of the second fluid flow increases the surface area for heat transfer between the first and second fluids.

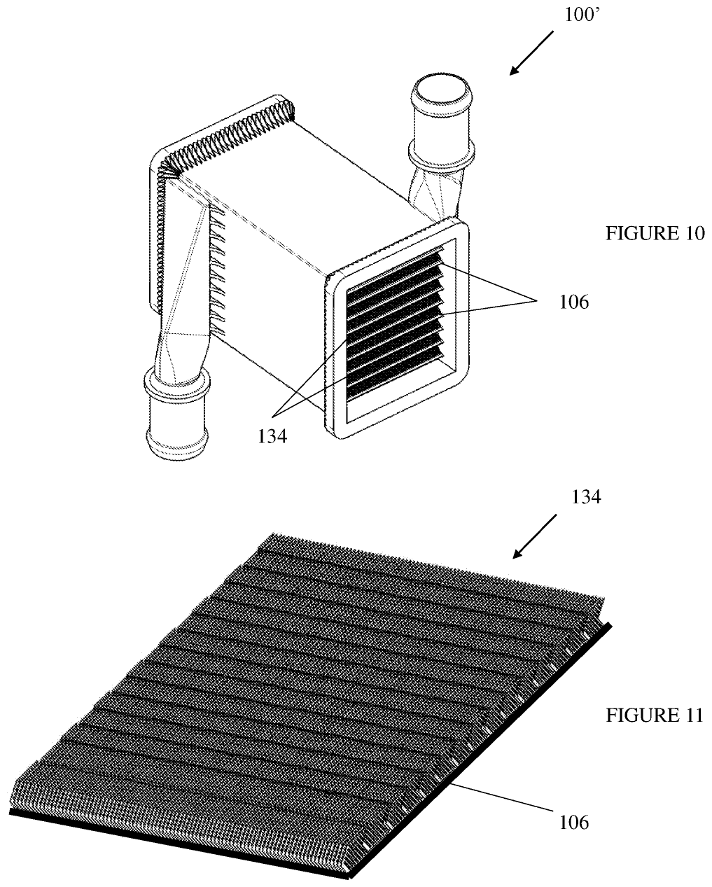

Preferably, the plates 106 can include external projections 134 that extend from outer faces thereof into the respective passages 132 of the passageway 104. FIGS. 10 to 13 illustrate an exemplary embodiment of the invention in the form of heat exchanger unit 100′ which includes plates 106 with external projections 134. It is understood that heat exchanger unit 100′ is otherwise analogous to heat exchanger unit 100, with the difference being in the provision of the external projections between the internal members 106, within the passageway. The external projections 134 promote improved mixing and heat transfer, working the first fluid flow within the passageway 104 by increasing the surface area of the plates 106 about which said first fluid flow passes.

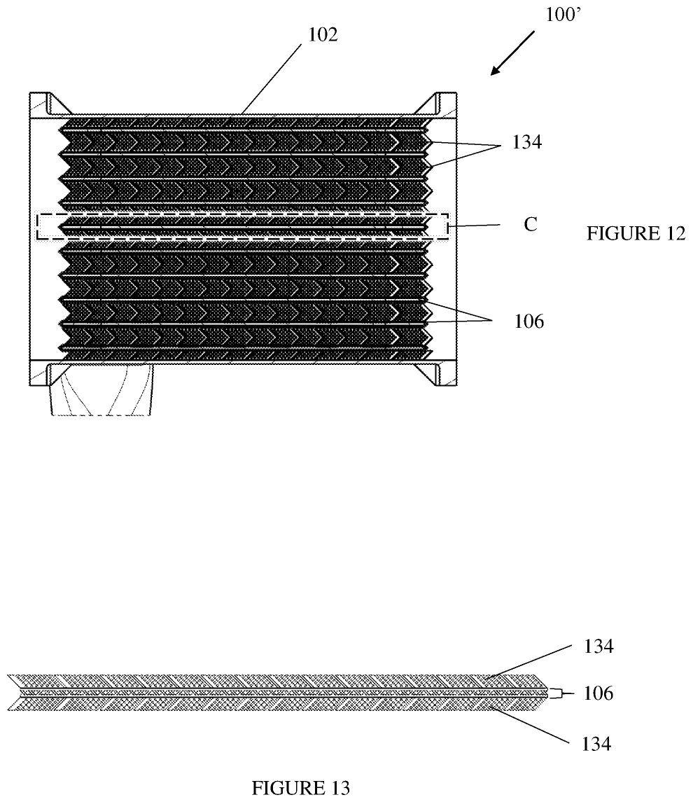

Best shown in FIG. 12, the external projections 134 are provided as an array of chevron-shaped interlocking fins, with each fin extending laterally across the width of the passageway 104. Each fin has a porous structure to permit fluid flow therethrough, such that the first fluid flow within the passageway passes through the porous structure of the fins 134. The porous structure be in the form of a honeycomb arrangement. The porous structure of the fins occupies a substantial volume of the passageway 104 and results in a labyrinthine flow path for the first fluid, promoting mixing and heat transfer with the second fluid. The height of the projections 134 is selected based on the flow characteristics of the first fluid, to encourage heat transfer. For example, as shown, the projections 134 extend substantially between adjacent plates 106. Furthermore, it is understood that the length of the respective fins may vary along the passageway 104—for example, fins located closer to the inlet end 128 may be longer than the fins located closer to the outlet end 130. This variable fin length can be tuned to suit the particular fluid, in order to optimize heat transfer performance along the passageway 104. Whilst not illustrated, it is also contemplated that like protuberances 140, projections 134 may be provided as a unitary lattice, as opposed to a plurality of discrete fins.

Like protuberances 140, the projections 134 may also provide reinforcement to the plates 106, acting as a scaffold to hold the plates 106 in place during an additive manufacturing process and allow for the housing 102 to be additively manufactured without compromising the structural integrity of the plates 106. Whilst the illustrated embodiment shows the projections 134 as extending substantially completely between the intake 124 and exhaust 126, it is also contemplated that the projections 134 may only extend partially along the passageway 104. Furthermore, whilst described herein as projections that are integrally formed with the respective plates 106, it is understood that, alternatively, separate conductive spacing members 134′ (not shown) may be provided within the gaps between adjacent plates 106 to provide a similar function.

Whilst not limiting, it is envisaged that the heat exchanger unit 100 (and thus heat exchanger unit 100′) as described herein is manufactured using an additive manufacturing process, with the housing 102 and the internal member 106 being integrally formed with one another as a monolithic structure. Preferably, the housing 102 and internal member 106 are formed simultaneously. For example, the unit 100 can be formed using a laser powder bed fusion metal additive manufacturing process. Advantageously, the heat exchanger unit 100 when manufactured in accordance with such a method would not require separate assembly of positioning of the plates 106 within the passageway 104, and accordingly the potential failure modes of welded or bolted joints associated therewith are avoided. The resulting unit 100 is, accordingly, a seamless unitary component. Furthermore, minimal finishing of the completed part 100 is required. It is envisaged that at least the internal member 106 is formed of a thermally conductive material. Preferably, the internal member 106 is formed from a metallic material, such as steel, aluminum or titanium. Such example materials are known to be suitable for laser powder bed fusion processes.

Additionally, it is understood that the additive manufacturing process as described herein enables the protuberances 140 and projections 134 to be formed with complex, tunable geometries. What is meant by this is that the exact geometry of these flow-surface features can be altered to obtain specific flow characteristics, dependent on the nature of the fluids themselves. For example, viscous fluid flows may be associated with a higher density of flow-surface features than less viscous fluid flows. Furthermore, the channel 110 can be made within tighter tolerances and smaller in overall height than would be possible through conventional machining operations-thus providing the ability for an increased number of plates (and thus increased heat transfer surface area) to be distributed within a given passageway volume.

Summarily, it is to be understood that the heat exchanger unit 100 as described herein provides several performance advantages and manufacturability improvements over typical, existing designs. For example, the geometry of the active region 110 and the features 140 defining said region within the interior channel 108 of the plate 106 work and encourage the flow to spread across the full width of the channel 108 and therefore increase the heat transfer with the opposing external fluid flow.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

LEGEND

| | |
|---|---|
| 100 | Heat Exchanger Unit |
| 101 | Core |
| 102 | Housing |
| 104 | Passageway |
| 106 | Plate |
| 108 | Interior channel |
| 110 | Active region |
| 112 | Front end wall |
| 114 | Rear end wall |
| 116 | Near side wall |
| 118 | Far side wall |
| 120 | Lower wall |
| 122 | Upper wall |
| 124 | Intake |
| 126 | Exhaust |
| 128 | Inlet |
| 130 | Outlet |
| 132 | Passages |
| 134 | External projections |
| 136 | Passive region |
| 138 | Transition |
| 140 | Internal protuberances |
| 142 | Manifold |

1. A heat exchanger for transferring heat between a first fluid and a second fluid, comprising:
a housing having a passageway for the first fluid; and
an internal member located within and extending along a length of the passageway that is configured to carry the second fluid in a direction substantially parallel to that of the first fluid,
wherein the internal member is formed from a thermally conductive material and includes an active region adapted to spread the second fluid flow substantially evenly across a width of the passageway.

2. The heat exchanger of claim 1, wherein the heat exchanger is a counterflow heat exchanger with the first and second fluids passing therethrough in substantially opposite directions.

3. The heat exchanger of claim 1, wherein the internal member comprises a plate having an interior channel for carrying the second fluid.

4. The heat exchanger of claim 1, further comprising an inlet and an outlet in fluid communication with the internal member, with one of the inlet and the outlet being located towards a first end of the internal member and the other of the inlet and the outlet being located towards an opposite second end of the internal member.

5. The heat exchanger of claim 4, wherein the internal member extends laterally between a first side and a second side, with the inlet being located on the first side and the outlet being located on the opposing second side.

6. The heat exchanger of claim 4, wherein the housing extends in height between an upper side and a lower side, with the inlet extending away from the lower side and the outlet extending away from the upper side.

7. The heat exchanger of claim 1, wherein the internal member includes a passive region, with the passive region being located before the active region in the direction of the second fluid flow, the passive region having a reduced surface friction in comparison to the active region.

8. The heat exchanger of claim 7, wherein the passive region of the internal member has a variable length across a width thereof.

9. The heat exchanger of claim 8, wherein the length of the passive region decreases across the width of the internal member, from a first side to an opposite second side.

10. The heat exchanger of claim 7, wherein the internal member includes a second passive region, with the second passive region being located after the active region in the direction of the second fluid flow.

11. The heat exchanger of claim 1, wherein the internal member includes a plurality of internal protuberances that define the active region.

12. The heat exchanger of claim 11, wherein the plurality of protuberances are provided as an array of discrete turbulators.

13. The heat exchanger of claim 1, wherein the internal member includes a plurality of external projections that extend into the passageway.

14. The heat exchanger of claim 1, wherein the internal member comprises a plurality of plates located within the passageway, with each of the plates having an interior channel along which a portion of the second fluid flow passes in the second direction.

15. The heat exchanger of claim 14, wherein the plurality of plates are spaced in a stacked arrangement within the passageway so as to divide the passageway into a plurality of substantially evenly sized separate passages, with portions of the first fluid flow passing therealong.

16. The heat exchanger of claim 14, further comprising a manifold configured to distribute the respective portions of the second fluid flow across the channels of the plurality of plates.

17. The heat exchanger of claim 1, wherein the first fluid flow is a gas flow.

18. The heat exchanger of claim 1, wherein the second fluid flow is a liquid flow.

19. The heat exchanger of claim 1, wherein the housing and the internal member are integrally formed with one another.

20. A method of manufacturing a heat exchanger of for transferring heat between a first fluid and a second fluid, the method including:
forming a housing having a passageway for the first fluid; and
forming an internal member located within and extending along a length of the passageway that is configured to carry the second fluid in a second direction of a second fluid flow substantially parallel to a first direction of a first fluid flow of the first fluid,
wherein the internal member is formed from a thermally conductive material and includes an active region adapted to spread the second fluid flow substantially evenly across a width of the passageway, and
wherein forming the housing and forming the internal member occurs simultaneously through an additive manufacturing process.
